(19) United States
(12) Patent Application Publication
(10) Pub. No.: US 2026/0347087 A1
(43) Pub. Date: Nov. 5, 2026

(54) MULTI-STAGE VEHICLE STACKING APPARATUS AND ASSEMBLY METHOD THEREFOR

(71) Applicants: Hyundai Motor Company, Seoul (KR); Kia Corporation, Seoul (KR); KOREA CONTAINER POOL CO., LTD., Seoul (KR)

(72) Inventors: Geun Min LEE, Gyeonggi-do (KR); Bum Tae KIM, Ulsan (KR); Sang Duck HAN, Gyeonggi-do (KR); Min Kwun JUNG, Gyeonggi-do (KR); Sang Hoon PARK, Seoul (KR); Chang Hun SONG, Gyeonggi-do (KR); Hyung Suk YUN, Seoul (KR)

(21) Appl. No.: 19/484,853

(22) PCT Filed: Jan. 11, 2024
(86) PCT No.: PCT/KR2024/000540

§ 371 Date: Nov. 14, 2025

(30) Foreign Application Priority Data
Jun. 19, 2023 (KR) 10-2023-0078463

(51) Int. Cl. B65D 85/62; B65D 85/68

(52) U.S. Cl. CPC B65D 85/62; B65D 85/68; B65D 2585/6867

(57) ABSTRACT

The present invention relates to a multi-stage vehicle stacking apparatus and an assembly method therefor. Disclosed is a prefabricated multi-stage vehicle stacking apparatus in which a plurality of stacked vehicles are stacked in the vertical direction, the apparatus comprising: a stacking base for supporting the lower part a lower-stacked vehicle; front side frames each attached to one of the two sides of the stacking base and extended upward; rear side frames provided at the rear of the front side frames, and each attached to one of the two sides of the stacking base and extended upward; a front cross frame for connecting the upper ends of the two front side frames thereof to each other and supporting the lower part of an upper-stacked vehicle; and a rear cross frame for connecting the upper ends of the two rear side frames thereof to each other and supporting the lower part of the upper-stacked vehicle.

### TECHNICAL FIELD

The present disclosure relates to a multi-stage vehicle stacking apparatus and an assembly method therefor. More particularly, the present disclosure relates to a multi-stage vehicle stacking apparatus in which each frame constituting a structure capable of stacking vehicles therein is prefabricated and which is capable of stacking various types of vehicles therein, and relates to and an assembly method for the multi-stage vehicle stacking apparatus.

### BACKGROUND ART

Generally, a vehicle is transported to a dealership or a logistics warehouse, or is transported to a loading/unloading station for overseas export. During such a vehicle transportation operation, a predetermined number of vehicles are loaded into a cargo transportation space such as a container.

Alternatively, a stacking apparatus in which vehicles are capable of being stacked therein in a multi-stage manner is provided and the vehicles are stacked in the stacking apparatus. As such a stacking apparatus is manufactured in a welding manner, a component constituting the stacking apparatus is required to be disassembled and then disposed after one use, and there is a problem that a large amount of waste is generated when the stacking apparatus is not used. In addition, since the stacking apparatus is manufactured in the welding manner, it is difficult to stack various types of vehicles in the stacking apparatus, so that there is a problem that loading efficiency of the vehicles is poor.

Accordingly, a stacking apparatus in which each frame constituting the stacking apparatus is coupled to each other in an assembly manner and in which various types of vehicles are capable of being stacked therein is required.

When the vehicles are stacked inside a container, it is preferable to stack a larger number of vehicles by using space inside the container so as to reduce the vehicle transportation cost and to increase the transportation efficiency. Accordingly, in a conventional vehicle stacking method, vehicles are stacked in a multi-stage manner inside a container by using a separate vehicle loading apparatus manufactured by welding, or are stacked by using a method in which the vehicles are suspended by simply using cables and then fixed inside the container.

However, when a vehicle is stacked in a container by using the conventional vehicle loading apparatus or when a vehicle is transported in a container by using the cables, the container is significantly shaken during transportation, so that rolling of a vehicle stacked inside the container occurs severely. Therefore, a position of the vehicle may be changed, the vehicle may collide with the inside of the container, and the vehicle may collide with another vehicle stacked inside the container, so that the vehicle may be partially damaged or a scratch may be formed on the vehicle.

The foregoing is intended merely to aid in the understanding of the background of the present disclosure, and is not intended to mean that the present disclosure falls within the purview of the related art that is already known to those skilled in the art.

### DISCLOSURE

### Technical Problem

Accordingly, an objective of the present disclosure is to provide a multi-stage vehicle stacking apparatus and an assembly method for the multi-stage vehicle stacking apparatus in which each frame constituting a structure capable of stacking vehicles in a multi-stage manner is prefabricated such that the multi-stage vehicle stacking apparatus is capable of being reused so that waste is reduced and in which various types of vehicles are capable of being stacked therein so that transportation efficiency is increased.

The technical problems to be solved by the present disclosure are not limited to the above-mentioned problems, and other problems which are not mentioned will be clearly understood by those skilled in the art from the following description.

### Technical Solution

In order to achieve the objective of the present disclosure, according to an aspect of the present disclosure, there is provided a prefabricated multi-stage vehicle stacking apparatus in which a plurality of vehicles is stacked in upper and lower stages, the multi-stage vehicle stacking apparatus including: a stacking base supporting a lower portion of a lower-stacked vehicle; front side frames, each assembled on both sides of the stacking base and extending upward; rear side frames, each provided at rear of the front side frames, the rear side frames being assembled on the both sides of the stacking base and extending upward; a front cross frame connecting upper ends of both the front side frames to each other and supporting a lower portion of an upper-stacked vehicle; and a rear cross frame connecting upper ends of both the rear side frames to each other and supporting the lower portion of the upper-stacked vehicle.

For example, the multi-stage vehicle stacking apparatus may further include a lower cross frame connecting the both sides of the stacking base to each other and supporting the lower portion of the lower-stacked vehicle, wherein the lower cross frame may be fastened to the stacking base while being in a state in which the lower cross frame is coupled to the lower portion of the lower-stacked vehicle, thereby supporting the lower portion of the lower-stacked vehicle.

For example, both ends of the lower cross frame may be bolt-fastened to a stacking frame in a first direction.

For example, connecting brackets may protrude inwardly on the upper ends of the front side frames and the rear side frames, and end portions of the front cross frame and the rear cross frame may be respectively fixed to the connecting brackets by being bolt-fastened thereto in a first direction.

For example, the upper ends of the front side frames and the rear side frames may be formed as sprockets configured to be rotated together with a rotation of the front cross frame and the rear cross frame according to a bolt fastening state.

For example, the sprockets may be configured such that the sprockets are capable of being separated from the front side frames, and wherein the multi-stage vehicle stacking apparatus may further include a connection adapter inserted between the sprockets and the front side frames so that a height at which the upper-stacked vehicle is supported is capable of being adjusted.

For example, the connection adapter may be formed in an “L” shape having a cross-sectional surface of a first side thereof open, and may be configured such that the height at which the upper-stacked vehicle is supported is adjusted according to a direction in which the connection adapter is rotated and inserted between the sprockets and the front side frames.

For example, lower ends of each of the front side frames may be assembled on the stacking base by being bolt-fastened to the stacking base in a first direction, and a plurality of fastening holes may be formed in the stacking base such that positions of the front side frames are adjusted and the front side frames are bolt-fastened to the stacking base.

For example, each of the front side frames may be formed in a triangular shape such that lower ends of each of the front side frames meet two points on one side of the stacking base so as to support a load of the upper-stacked vehicle.

For example, the stacking base, the front side frames, the rear side frames, the front cross frame, and the rear cross frame may be formed such that the stacking base, the front side frames, the rear side frames, the front cross frame, and the rear cross frame are capable of being separated from each other while being in an assembled state.

For example, a vertical length of the rear side frames may be larger than a vertical length of the front side frames, so that the upper-stacked vehicle may be stacked in a diagonal direction while upper-stacked vehicle is staggered with respect to the lower-stacked vehicle.

In order to achieve the objective of the present disclosure, according to an aspect of the present disclosure, there is provided an assembly method for a multi-stage vehicle stacking apparatus including stacking base supporting a lower portion of a lower-stacked vehicle, the assembly method including: assembling front side frames on the both sides of the stacking base, each extending upward from both sides of the stacking base; assembling rear side frames on the both sides of the stacking base, the rear side frames being provided at rear of the front side frames and extending upward; assembling a front cross frame such that the front cross frame connects upper ends of both the front side frames to each other, the front cross frame supporting a lower portion of an upper-stacked vehicle; and assembling a rear cross frame such that the rear cross frame connects upper ends of both the rear side frames to each other, the rear cross frame supporting the lower portion of the upper-stacked vehicle.

For example, the assembly method may further include: coupling a lower cross frame to the lower portion of the lower-stacked vehicle so as to support the lower portion of the lower-stacked vehicle; and assembling the lower cross frame on the stacking base while the lower cross frame is in state in which the lower cross frame is coupled to the lower portion of the lower-stacked vehicle.

### Advantageous Effects

According to the multi-stage vehicle stacking apparatus of the present disclosure, since the multi-stage vehicle stacking apparatus is configured such that each frame constituting the structure capable of stacking vehicles in the multi-stage manner is prefabricated such that the multi-stage vehicle stacking apparatus is capable of being reused, the waste may be reduced. Furthermore, since various types of vehicles are capable of being stacked in the multi-stage vehicle stacking apparatus, the transportation efficiency may be increased.

The effects that can be obtained from the present disclosure are not limited to the above-mentioned effects, and other effects not mentioned herein will be clearly understood by those skilled in the art from the following description.

### DESCRIPTION OF DRAWINGS

FIG. 1 and FIG. 2 are views illustrating a multi-stage vehicle stacking apparatus according to an embodiment of the present disclosure.

FIG. 3 is a view illustrating a lower cross frame coupled to a lower portion of a lower-stacked vehicle according to an embodiment of the present disclosure.

FIG. 4 is a view illustrating a point where front side frames and rear side frames are respectively connected to a front cross frame and a rear cross frame according to an embodiment of the present disclosure.

FIG. 5 is a view illustrating a state in which a connection adapter is inserted between sprockets and the front side frames according to an embodiment of the present disclosure.

FIG. 6 is a flowchart showing an assembly process of the multi-stage vehicle stacking apparatus according to an embodiment of the present disclosure.

### MODE FOR INVENTION

Hereinafter, exemplary embodiments disclosed in the present specification will be described in detail with reference to the accompanying drawings. In the present specification, the same or similar components will be denoted by the same or similar reference numerals, and a repeated description thereof will be omitted.

In the following description, the expressions “module” and “part” contained in terms of constituent components to be described will be selected or used together in consideration only of the convenience of writing the following specification, and the expressions “module” and “part” do not necessarily have different meanings or roles.

Detailed description of known technologies will be omitted if it is determined that the detailed description of the known technologies obscures the embodiments of the present specification. In addition, the accompanying drawings are merely intended to easily describe the embodiments of the present specification, but the spirit and technical scope of the present specification is not limited by the accompanying drawings. It should be understood that the present specification is not limited to specific disclosed embodiments, but includes all modifications, equivalents and substitutes included within the spirit and technical scope of the present disclosure. Terms including ordinals such as “first” or “second” used herein may be used to describe various components, but the components are not limited by the terms. The terms are used only for the purpose of distinguishing one constituent element from another constituent element.

When a component is described as being “connected”, “coupled”, or “linked” to another component, that component may be directly connected, coupled, or linked to that other component. However, it should be understood that yet another component between each of the components may be present. In contrast, it should be understood that when a component is referred to as being “directly coupled” or “directly connected” to another component, there are no intervening components present.

Singular expressions include plural expressions unless the context clearly indicates otherwise.

It is to be understood that the terms such as “comprise” or “have” are used to designate presence of a characteristic, a number, an operation, a component, a part or a combination thereof, and not to preclude presence of or possibility of adding one or more other characteristics, numbers, steps, operations, components, parts or a combination thereof.

According to an embodiment of the present disclosure, there is provided a multi-stage vehicle stacking apparatus configured such that each frame constituting a structure capable of stacking vehicles in a multi-stage manner is configured in a prefabricated manner so that each frame is capable of being reused, thereby reducing waste generation and realizing stacking of various types of vehicles.

In the multi-stage vehicle stacking apparatus of the present disclosure, two vehicles are stacked in the multi-stage vehicle stacking apparatus, wherein one vehicle stacked on an upper portion of the multi-stage vehicle stacking apparatus is referred to as an upper-stacked vehicle and the other vehicle stacked below the upper-stacked vehicle is referred to as a lower-stacked vehicle. Hereinafter, the present disclosure will be described in detail.

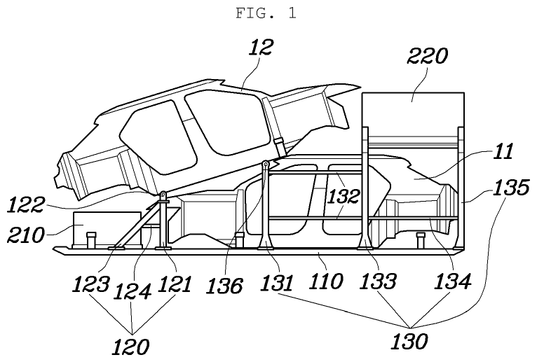

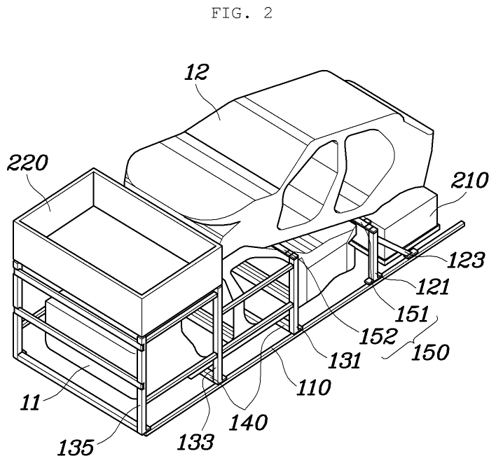

FIG. 1 and FIG. 2 are views illustrating a multi-stage vehicle stacking apparatus according to an embodiment of the present disclosure. FIG. 1 and FIG. 2 mainly illustrate components related to the present embodiment, and the multi-stage vehicle stacking apparatus may include more or fewer components when an actual multi-stage vehicle stacking apparatus is realized.

Referring to FIG. 1 and FIG. 2, the multi-stage vehicle stacking apparatus according to an embodiment is configured such that a plurality of vehicles is stacked in upper and lower stages in the multi-stage vehicle stacking apparatus, and may include a stacking base 110, front side frames 120, rear side frames 130, a front cross frame 151, and a rear cross frame 152.

The stacking base 110 is configured such that the stacking base 110 is positioned parallel to the ground surface, and may support a lower portion of a lower-stacked vehicle 11. The stacking base 110 is a base frame to which a load of the lower-stacked vehicle 11 and a load of an upper-stacked vehicle 12 are finally transferred, and may be formed in a structure capable of withstanding a high load.

The front side frames 120 may be assembled on both sides of the stacking base 110 and may extend upward. The front side frames 120 are fixed to both sides of a front portion of the lower-stacked vehicle 11, and each of the front side frames 120 is formed in the same shape. As illustrated in FIG. 1, the front side frames 120 may have a triangular shape in which lower ends of each of the front side frames 120 meet two points on one side of the stacking base 110. More specifically, the front side frames 120 may include a first front bracket 121, a second front bracket 123, and a third front bracket 124. The first front bracket 121 has a lower end thereof coupled to the stacking base 110 and extends upward perpendicular to the stacking base 110, and the second front bracket 123 extends diagonally from a first upper end 122 of the front side frames 120 so that a lower end of the second front bracket 123 is supported on the stacking base 110.

In addition, the third front bracket 124 connects the first front bracket 121 and the second front bracket 123 to each other while being disposed in a direction parallel to the stacking base 110, so that the rigidity of the front side frames 120 may be increased. The configuration of the front side frames 120 and the corresponding arrangement structure of the front side frames 120 are provided such that the front side frames 120 are capable of rigidly supporting the upper-stacked vehicle 12 in a direction in which a biased load is transmitted when the upper-stacked vehicle 12 is disposed in a tilted state with the center of gravity thereof biased to one side. Through this, durability of the stacking apparatus is secured, and the stacking apparatus is capable of being reused later. In addition, a first box 210 and a second box 220 may be respectively provided on the front side and the rear side of the stacking apparatus according to the present disclosure. Each box is formed with an open upper portion, so that cargo is capable of being accommodated therein. By placing each box having such a structure in an idle space, it is possible to transport more cargo within a single container.

In addition, the lower ends of the front side frames 120 may be connected to the stacking base 110 in a first direction. An end portion of each of the first front bracket 121 and the second front bracket 123 that constitutes the front side frames 120 is formed in a flange shape, and may be assembled by being bolt-fastened to an upper surface of the stacking base 110 in the vertical direction. Through this, after use of the stacking apparatus, the disassembly between the stacking base 110 and the front side frames 120 is capable of being realized in reverse order of assembly. Here, a plurality of fastening holes for allowing positions of the front side frames 120 to be adjusted and then allowing the front side frames 120 to be bolt-fastened to the stacking base 110 may be formed in the stacking base 110.

This configuration is provided such that the position where the front side frames 120 are fastened to the stacking base 110 is capable of being adjusted so that various types of vehicles are capable of being stacked above the lower-stacked vehicle 11. Accordingly, the front side frames 120 are capable of being moved frontward when a vehicle having a large overall width is stacked, and the front side frames 120 are capable of being moved rearward when a vehicle having small overall width is stacked. Through this, a vehicle having various sizes, which is as the upper-stacked vehicle 12, is capable of being stacked, so that a stacking angle of the vehicle is capable of being adjusted, thereby being capable of increasing vehicle transportation efficiency.

Hereinafter, the rear side frames 130, the front cross frame 151, and the rear cross frame 152 that constitute the multi-stage vehicle stacking apparatus will be described.

The rear side frames 130 are provided at rear of the front side frames 120, may be assembled on the both sides of the stacking base 110, and may extend upward. Referring to FIG. 1, the rear side frames 130 may include a first rear bracket 131, a second rear bracket 132, a third rear bracket 133, a fourth rear bracket 134, and a fifth rear bracket 135. A lower end of each of the first rear bracket 131, the third rear bracket 133, and the fifth rear bracket 135 is coupled to the stacking base 110, and extends upward perpendicular to the stacking base 110. In addition, the second rear bracket 132 provided in a direction parallel to the stacking base 110 connects the first rear bracket 131 and the third rear bracket 133 to each other, and the fourth rear bracket 134 provided in the direction parallel to the stacking base 110 connects the third rear bracket 133 and the fifth rear bracket 135 to each other. Through the second rear bracket 132 and the fourth rear bracket 134, the overall rigidity of the rear side frames 130 may be increased.

At this time, the rear side frames 130 are formed such that a vertical length of the rear side frames 130 is longer than a vertical length of the front side frames 120, so that the upper-stacked vehicle 12 may be stacked in a diagonal direction by being staggered with respect to the lower-stacked vehicle 11. Through this, the upper-stacked vehicle 12 is disposed in a state in which the upper-stacked vehicle 12 is tilted toward the front side frames 120, the front side frames 120 are capable of supporting the upper-stacked vehicle 12 in a direction in which the biased load is transmitted. Through this, the durability of the stacking apparatus is secured, and the stacking apparatus is capable of being reused later.

Hereinafter, a lower cross frame 140 and an upper cross frame that are respectively supporting the lower portion of the lower-stacked vehicle 11 and the lower portion of the upper-stacked vehicle 12 will be described.

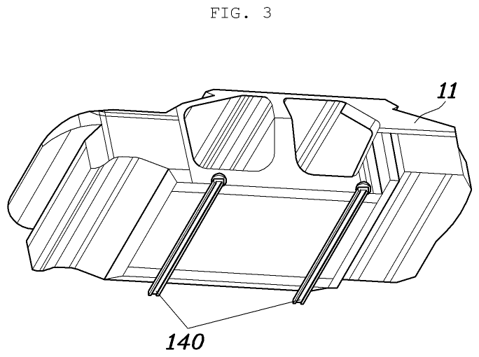

FIG. 3 is a view illustrating the lower cross frame 140 coupled to the lower portion of the lower-stacked vehicle 11 according to an embodiment of the present disclosure.

The lower cross frame 140 is connected to the both sides of the stacking base 110, and both ends of the lower cross frame 140 may be fixed to a stacking frame by being bolt-fastened to the stacking frame in the vertical direction. Referring to FIG. 3, in order for the lower cross frame 140 to be fixed to the stacking base 110, the lower cross frame 140 is required to be coupled to the lower-stacked vehicle 11 first. Then, as the end portions of the lower cross frame 140 are fastened to the stacking base 110, the lower portion of the lower-stacked vehicle 11 may be supported on the lower cross frame 140.

The upper cross frame may include the front cross frame 151 and the rear cross frame 152. The front cross frame 151 may connect the first upper ends 122 of both the front side frames 120 to each other, and the rear cross frame 152 may connect second upper ends 136 of both the rear side frames 130 to each other. Both the front cross frame 151 and the rear cross frame 152 may respectively be connected to the front side frames 120 and the rear side frames 130 so that the lower portion of the upper-stacked vehicle 12 is supported on the front cross frame 151 and the rear cross frame 152.

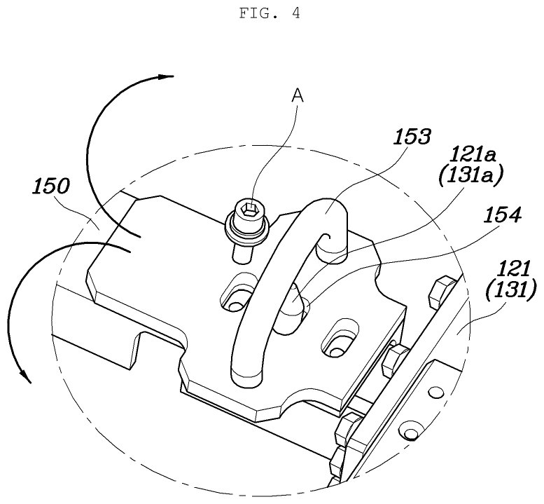

FIG. 4 is a view illustrating a point where the front side frames 120 and the rear side frames 130 are respectively connected to the front cross frame 151 and the rear cross frame 152 according to an embodiment of the present disclosure.

Referring to FIG. 4, it can be seen that connecting brackets 126 and 137 protrude inwardly on the upper ends 122 and 136 of the front side frames 120 and the rear side frames 130. The connecting brackets 126 and 137 are configured such that end portions of the front cross frame 151 and the rear cross frame 152 are connected to the respective connecting brackets 126 and 137 in a bolt-fastening manner A, so that disassembly of each frame is capable of being conveniently performed. fixing pins 121a and 131a that extend upward are formed from on upper surfaces of the connecting brackets 126 and 137, and the fixing pins 121a and 131a are inserted into respective penetration holes 154 formed in the end portions of the front cross frame 151 and the rear cross frame 152, so that lateral swing of the front cross frame 151 and the rear cross frame 152 are capable of being regulated with the bolt-fastening manner A. hoist connecting rings 153 are respectively formed on the front cross frame 151 and the rear cross frame 152, so that the hoist connecting rings 153 are capable of being used when the upper-stacked vehicle 12 is lifted upward and is loaded on the stacking apparatus.

At this time, the upper ends 122 and 136 of the front side frames 120 and the rear side frames 130 may be formed as sprockets. A sprocket refers to a wheel configured to be moved by being engaged with a chain or a track. Whether the sprockets are locked or not is determined according to whether a bolt provided on an outer side surface of the sprocket is fastened or not. Furthermore, whether the front cross frame 151 and the rear cross frame 152 are rotated or fixed are determined according to whether the sprockets are locked or not. Through this, a vehicle having various sizes, which is as the upper-stacked vehicle 12, is capable of being stacked, so that a stacking angle of the vehicle is capable of being adjusted, thereby being capable of increasing vehicle transportation efficiency.

The stacking base 110, the front side frames 120, the rear side frames 130, the front cross frame 151, and the rear cross frame 152 that are described above may be formed such that the stacking base 110, the front side frames 120, the rear side frames 130, the front cross frame 151, and the rear cross frame 152 are capable of being separated from each other in the assembled state. As each frame in the stacking apparatus is prefabricated, the stacking apparatus is capable of being reused, and various types of vehicles are capable of being stacked in the stacking apparatus. Furthermore, an effect that the storage cost of the stacking apparatus is reduced may be realized when the stacking apparatus is disassembled and stored.

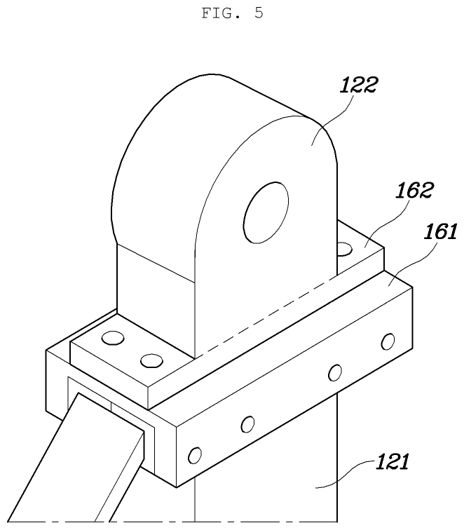

FIG. 5 is a view illustrating a state in which a connection adapter 161 is inserted between the sprockets and the front side frames 120 according to an embodiment of the present disclosure.

Referring to FIG. 5, the sprockets may be configured such that the sprockets are capable of being separated from the front side frames 120, and the connection adapter 161 is capable of being inserted between the sprockets and the front side frames 120. The connection adapter 161 may be configured such that a height at which the upper-stacked vehicle 12 is supported is capable of being adjusted. A shape of the connection adapter 161 may be formed in an “L” shape in which a cross-sectional surface of a first side of the connection adapter 161 is open. Here, a thickness of each surface of the connection adapter 161 may be different from each other so that the height at which the upper-stacked vehicle 12 is supported is capable of being adjusted according to a direction in which the connection adapter 161 is rotated and inserted between the sprockets and the front side frames 120. In addition, when an additional height adjustment is required, an additional adapter 162 may be inserted between the sprockets and the front side frames 120. When the additional adapter 162 is not used, the additional adapter 162 may be fixed to a side surface of the front side frames 120, and may be used by detaching the additional adapter 162 from the side surface of the front side frames 120 as required. A vehicle having various sizes, which is as the upper-stacked vehicle 12, is capable of being stacked by using the connection adapter 161 and the additional adapter 162, so that a stacking angle of the vehicle is capable of being adjusted, thereby being capable of increasing the vehicle transportation efficiency.

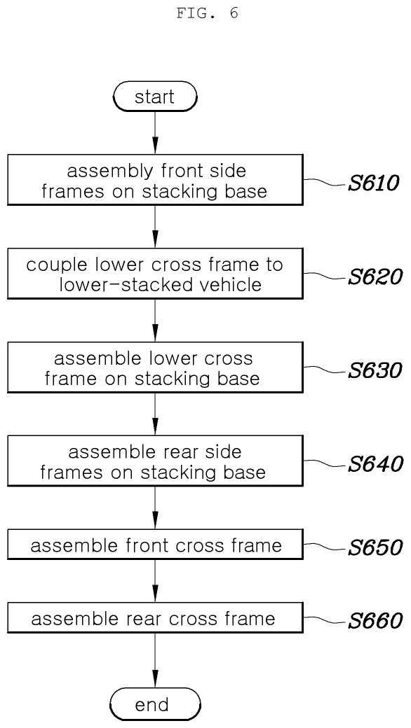

On the basis of the configuration of the multi-stage vehicle stacking apparatus described above, an assembly method for the multi-stage vehicle stacking apparatus according to an embodiment will be described with reference to FIG. 6.

FIG. 6 is a flowchart showing an assembly process of the multi-stage vehicle stacking apparatus according to an embodiment of the present disclosure.

Referring to FIG. 6, the front side frames 120 may be assembled on the stacking base 110 first (S610). Subsequently, the lower cross frame 140 may be coupled to the lower-stacked vehicle 11 (S620), and the lower cross frame 140 to which the lower-stacked vehicle 11 is coupled may be assembled on the stacking base 110 (S630). From rear of the front side frames 120, the rear side frames 130 may be assembled on the stacking base 110 (S640). Subsequently, the front cross frame may be assembled such that the upper ends 122 of both the front side frames 120 are connected to each other (S650), and the rear cross frame 152 may be assembled such that the upper ends 136 of both the rear side frames 130 are connected to each other (S660). Subsequently, the upper-stacked vehicle 12 may be stacked on the upper portion of the stacking apparatus by using the connecting ring 153.

According to the embodiments of the present disclosure described above, since the multi-stage vehicle stacking apparatus is configured such that each frame constituting the structure capable of stacking vehicles in the multi-stage manner is prefabricated such that the multi-stage vehicle stacking apparatus is capable of being reused, the waste may be reduced. Furthermore, since various types of vehicles are capable of being stacked in the multi-stage vehicle stacking apparatus, the transportation efficiency may be increased.

Although exemplary embodiments of the present disclosure have been described herein, it is understood that the present disclosure should not be limited to these exemplary embodiments and that various changes and modifications can be made by one ordinary skilled in the art within the spirit and scope of the present disclosure.

### DESCRIPTION OF REFERENCE NUMERALS

11: lower-stacked vehicle 12: upper-stacked vehicle
110: stacking base 120: front side frame
121: first front bracket 121a, 131a: fixing pins
122: first upper end 123: second front bracket
124: third front bracket 126, 137: connecting bracket
130: rear side frame 131: first rear bracket
132: second rear bracket 133: third rear bracket
134: fourth rear bracket 135: fifth rear bracket
136: second upper end 140: lower cross frame
151: front cross frame 152: rear cross frame
153: connecting ring 154: penetration hole
161: connection adapter 162: additional adapter
210: first box 220: second box

1. A prefabricated multi-stage vehicle stacking apparatus in which a plurality of vehicles is stacked in upper and lower stages, the multi-stage vehicle stacking apparatus comprising:
a stacking base supporting a lower portion of a lower-stacked vehicle;
front side frames, each assembled on both sides of the stacking base and extending upward;
rear side frames, each provided at rear of the front side frame, the rear side frames being assembled on the both sides of the stacking base and extending upward;
a front cross frame connecting upper ends of both the front side frames to each other and supporting a lower portion of an upper-stacked vehicle; and
a rear cross frame connecting upper ends of both the rear side frames to each other and supporting the lower portion of the upper-stacked vehicle.

2. The multi-stage vehicle stacking apparatus of claim 1, further comprising:
a lower cross frame connecting the both sides of the stacking base to each other and supporting the lower portion of the lower-stacked vehicle,
wherein the lower cross frame is fastened to the stacking base while being in a state in which the lower cross frame is coupled to the lower portion of the lower-stacked vehicle, thereby supporting the lower portion of the lower-stacked vehicle.

3. The multi-stage vehicle stacking apparatus of claim 2, wherein both ends of the lower cross frame are bolt-fastened to a stacking frame in a first direction.

4. The multi-stage vehicle stacking apparatus of claim 1, wherein connecting brackets protrude inwardly on the upper ends of the front side frames and the rear side frames, and end portions of the front cross frame and the rear cross frame are respectively fixed to the connecting brackets by being bolt-fastened thereto in a first direction.

5. The multi-stage vehicle stacking apparatus of claim 1, wherein the upper ends of the front side frames and the rear side frames are formed as sprockets configured to be rotated together with a rotation of the front cross frame and the rear cross frame according to a bolt fastening state.

6. The multi-stage vehicle stacking apparatus of claim 5, wherein the sprockets are configured such that the sprockets are capable of being separated from the front side frames, and
wherein the multi-stage vehicle stacking apparatus further comprises:
a connection adapter inserted between the sprockets and the front side frames so that a height at which the upper-stacked vehicle is supported is capable of being adjusted.

7. The multi-stage vehicle stacking apparatus of claim 6, wherein the connection adapter is formed in an “L” shape having a cross-sectional surface of a first side thereof open, and is configured such that the height at which the upper-stacked vehicle is supported is adjusted according to a direction in which the connection adapter is rotated and inserted between the sprockets and the front side frames.

8. The multi-stage vehicle stacking apparatus of claim 1, wherein lower ends of each of the front side frames are assembled on the stacking base by being bolt-fastened to the stacking base in a first direction, and a plurality of fastening holes is formed in the stacking base such that positions of the front side frames are adjusted and the front side frames are bolt-fastened to the stacking base.

9. The multi-stage vehicle stacking apparatus of claim 1, wherein each of the front side frames is formed in a triangular shape such that lower ends of each of the front side frames meet two points on one side of the stacking base so as to support a load of the upper-stacked vehicle.

10. The multi-stage vehicle stacking apparatus of claim 1, wherein the stacking base, the front side frames, the rear side frames, the front cross frame, and the rear cross frame are formed such that the stacking base, the front side frames, the rear side frames, the front cross frame, and the rear cross frame are capable of being separated from each other while being in an assembled state.

11. The multi-stage vehicle stacking apparatus of claim 1, wherein a vertical length of the rear side frames is larger than a vertical length of the front side frames, so that the upper-stacked vehicle is stacked in a diagonal direction while the upper-stacked vehicle is staggered with respect to the lower-stacked vehicle.

12. An assembly method for a multi-stage vehicle stacking apparatus comprising a stacking base supporting a lower portion of a lower-stacked vehicle, the assembly method comprising:
assembling front side frames on the both sides of the stacking base, each extending upward from both sides of the stacking base;
assembling rear side frames on the both sides of the stacking base, the rear side frames being provided at rear of the front side frames and extending upward;
assembling a front cross frame such that the front cross frame connects upper ends of both the front side frames to each other, the front cross frame supporting a lower portion of an upper-stacked vehicle; and
assembling a rear cross frame such that the rear cross frame connects upper ends of both the rear side frames to each other, the rear cross frame supporting the lower portion of the upper-stacked vehicle.

13. The assembly method of claim 12, further comprising:
coupling a lower cross frame to the lower portion of the lower-stacked vehicle so as to support the lower portion of the lower-stacked vehicle; and
assembling the lower cross frame on the stacking base while the lower cross frame is in a state in which the lower cross frame is coupled to the lower portion of the lower-stacked vehicle.
